(19) United States
(12) Patent Application Publication
(10) Pub. No.: US 2025/0055485 A1
(43) Pub. Date: Feb. 13, 2025

(54) SYSTEM FOR THE SELECTION OF AT LEAST ONE FREQUENCY CHANNEL IN AN INPUT SIGNAL, CORRESPONDING RECEIVER AND INTEGRATED CIRCUIT

(71) Applicant: COMMISSARIAT A L'ENERGIE ATOMIQUE ET AUX ENERGIES ALTERNATIVES, Paris (FR)

(72) Inventors: Pierre COUROUVE, Grenoble (FR); Ali ALSHAKOUSH, Grenoble (FR)

(73) Assignee: COMMISSARIAT A L'ENERGIE ATOMIQUE ET AUX ENERGIES ALTERNATIVES, Paris (FR)

(21) Appl. No.: 18/797,596

(22) Filed: Aug. 8, 2024

(30) Foreign Application Priority Data
Aug. 11, 2023 (EP) 23306368.4

(51) Int. Cl. H04B 1/00; H04B 1/16

(52) U.S. Cl. CPC H04B 1/0057; H04B 1/16

(57) ABSTRACT

A system is proposed for the selection of at least one frequency channel in an input signal. The system comprises: a gain block delivering H currents proportional to the input signal through a gain factor; and N processing paths for processing the currents. Each path comprises: one capacitor; and H branches, each branch being configured to provide, to the capacitor, a respective current, the H branches being configured for having the gain factors of the currents successively provided to the capacitor over a period T_{LO} that are representative of a respective sampled waveform which is the H first samples of a circular permutation of a sampled pattern obtained by time shift by a multiple of a sampling period T_{LO}/N. Each path comprises a reset switch, implemented in parallel of the capacitor, for resetting the voltage across the capacitor once per period T_{LO}.

### 1. FIELD OF THE DISCLOSURE

The field of the disclosure is that of the processing of a signal received by a receiver device.

More specifically, the disclosure relates to a system for the selection of one (or more) frequency channel(s) in such signal.

The disclosure can be of interest in any field wherein the selection of one (or more) frequency channel(s) in a received signal is of interest. This can be the case e.g. in the field of receivers for radars, for sonars, or for wireless communications, e.g. receivers for 5G, 3GPP LTE Pro, LiFi, and “Beyond 5G” standards), LAN (for “Local Area Network”), Home-area networks, etc.

### 2. TECHNOLOGICAL BACKGROUND

This document describes an existing problem in the field of wireless communications and with which the inventors of the present patent application have been confronted. The invention is of course not limited to this particular field of application, but is of interest in any field wherein the selection of one (or more) frequency channel(s) in a signal received by a receiver device is of interest.

The increasing number of connected devices in mobile and wireless applications leads to the allocation of new frequencies in the RF spectrum and to new standards. In the context of 5G which aims to aggregate several standards to improve the data rate, the need for multi-standard receivers is increased. The use of multiple parallel receivers where each one is dedicated to one specific application consumes much power and takes a large area.

Another solution is the use of a single receiver with one data processor that can cover a large number of frequencies. Such system requires wideband devices at the circuit level: wide band Low-Noise Amplifiers, wideband mixers and wideband local oscillators that cover almost a decade in order to cover the most important RF standards, e.g: Bluetooth, Zigbee, GSM, Wifi, etc. However, wideband receivers are sensitive to blockers and must be highly linear.

To mitigate this issue, agile circuits are preferred. In that context, harmonic rejection N-path filters, HR-NPF, or harmonic rejection N-path mixers, HR-NPM, seem suitable. For instance, the article from A L Shakoush, A. & Lauga-Larroze, Estelle & Subias, S. & Taris, T. & Podevin, Florence & Bourdel, S. “Low Complexity Architecture of N-Path Mixers for Low Power Application” 17th IEEE International New Circuits and Systems Conference (NEWCAS), 2019, describes such HR-NPM which is also illustrated in FIG. 1 and FIG. 1a.

More particularly, in FIG. 1 the receiving antenna is represented through its equivalent electrical circuit comprising the voltage source Vₛ and the internal resistor R that thus delivers a current proportional to the received input signal. Accordingly, the HR-NPM 100 comprises:
a gain block 110 delivering H currents, I₀, I₁, . . . , I_{H-1}, substantially proportional to the input signal through a respective gain factor, G₀, G₁, . . . , G_{H-1}, with H an integer greater than or equal to three;
N processing paths 120, with N an integer greater than or equal to H, for processing the H currents; and
a clock system 130 delivering N non-overlapping periodic clocks, S₁, S₂, . . . , S_{N}, hereafter sampling clocks, shifted by a duration substantially equal to T_{LO}/N in relation to each other, with T_{LO} the period of the sampling clocks. A ON state of the sampling clocks is substantially equal to T_{LO}/N.

In the present document the ON state of a clock corresponds to the state that turns ON the switch that is trigged by the clock in question. For instance, the ON state of a clock that trigs a NMOS type transistor is the high voltage level of the clock. Conversely, the ON state of a clock that trigs a PMOS type transistor is the low voltage level of the clock.

Back to FIG. 1 and FIG. 1a, each path 120 comprises:
a load capacitor C₁ or C₂ or . . . or C_{N}; and
H branches, each branch being configured for providing to the capacitor C₁ or C₂ or . . . or C_{N}, through a respective switch triggered by a respective sampling clock S₁ or S₂ or . . . or S_{N}, a respective current I₀ or I₁, or . . . or I_{H-1}. The H branches are configured for having the gain factors G₀, G₁, . . . , G_{H-1}, of the currents successively provided to the capacitor over a period T_{LO} that are representative of a respective sampled waveform.

More particularly, such HR-NPM 100 filters the spectrum of the input signal and further translates in frequency such spectrum by an amount equal to 1/T_{LO}. For that, the N respective sampled waveforms associated to the N paths are the H first samples (or, equivalently, the H successive samples starting from a same given sample index (i.e. the H successive samples starting from the first sample, or from the second sample, or from the third sample, etc.) as it leads to the same set of N sampled waveforms in any case) of the N circular permutations of a sampled pattern obtained by N successive time shifts of a sampling period T_{LO}/N. The sampled pattern is chosen so as to minimize the level of the harmonics at multiples of the frequency 1/T_{LO} (i.e. at the frequencies 2/T_{LO}, 3/T_{LO}, . . . , (N−2)/T_{LO}) and needs to correspond to a periodic function of period T_{LO}. In practice, the sampled pattern corresponds to samples of a sinewave of period T_{LO} as given by equation (2) in the above-mentioned article. We thus observe that the center frequency provided by such filtering is not flexible, at least independently of the tuning of the sampling clocks frequency 1/T_{LO}. Furthermore, the transfer function does not provide flexibility in its shape so that no more than one frequency channel can be selected simultaneously.

There is thus a need for a system that allows the selection of one (or more) frequency channel(s) in a signal in a flexible way.

### 3. SUMMARY

A particular aspect of the present disclosure relates to a system for the selection of at least one frequency channel in an input signal. Such system comprises:
a gain block (110) configured for delivering H currents substantially proportional to said input signal through a respective gain factor, H being an integer greater than or equal to three;
N processing paths (220), N being an integer greater than or equal to H, configured for processing said currents; and
a clock system (230, 530) configured for delivering N non-overlapping periodic clocks, hereafter sampling clocks, shifted by a duration substantially equal to T_{LO}/N in relation to each other, with T_{LO} being the period of the sampling clocks, a ON state of the sampling clocks being substantially equal to T_{LO}/N.
   Each path comprises:
an output stage comprising at least one capacitor; and
H branches, each branch being configured for providing to the at least one capacitor, through a respective switch triggered by a respective sampling clock among said N sampling clocks, a respective current among said H currents. The H branches are configured for having the gain factors of the currents successively provided to the at least one capacitor over a period T_{LO} that are representative of a respective sampled waveform.
   The N respective sampled waveforms associated to the N paths are H first samples (or, equivalently, the H successive samples starting from a same given sample index (i.e. the H successive samples starting from the first sample, or from the second sample, or from the third sample, etc.) as it leads to the same set of N sampled waveforms in any case) of the N circular permutations of a sampled pattern obtained by N successive time shifts of a sampling period T_{LO}/N. The output stage comprises at least one switch, hereafter reset switch, implemented in parallel of the at least one capacitor. The clock system is configured for delivering N clocks, hereafter reset clocks, each reset clock triggering a respective at least one reset switch for resetting the voltage across said at least one capacitor once per period T_{LO}.

Thus, the present disclosure proposes a new and inventive solution for selecting (e.g. through filtering and/or downmixing) one (or more) frequency channel(s) in a signal in a flexible way.

More particularly, the reset, at each period of the sampling clocks, of the voltage across the output capacitors of the N paths of a structure of the HR-NPF or HR-NPM type allows implementing a sampled pattern that does not need to be a periodic function of the sampling clocks period T_{LO}. This thus allows flexibility in the shape for the transfer function of the system. For instance, a transfer function exhibiting a bandpass behavior centered around the frequency channel(s) to be selected can be implemented.

In some embodiments, the sampled pattern corresponds to the sampling of a sinewave. A frequency of the sinewave is different from 1/T_{LO}. The at least one frequency channel comprises a frequency channel centered on the frequency of the sinewave.

Thus, the transfer function of the system exhibits a bandpass behavior centered around the frequency channel corresponding to the frequency of the sinewave.

In some embodiments, the sampled pattern corresponds to the sampling of a sum of sinewaves. The at least one frequency channel comprises, for each sinewave, a frequency channel centered on the frequency of the sinewave.

Thus, the transfer function of the system exhibits a bandpass behavior centered around the frequency channels corresponding to the frequencies of the sinewaves. The selection (or aggregation) of the frequency channels corresponding to the frequencies of the sinewaves is thus obtained.

In some embodiments, the at least one capacitor comprises a first capacitor and a second capacitor. The at least one reset switch comprises:
a first reset switch configured to ground the first capacitor for resetting the voltage across the first capacitor when the first reset switch is ON, and
a second reset switch configured to ground the second capacitor for resetting the voltage across the second capacitor when the second reset switch is ON.
   The output stage comprises at least one multiplexer configured for alternating between a first state and a second state, the change between the first state and the second state occurring at each sampling clock period T_{LO}. The output stage is configured for:
when the at least one multiplexer is in the first state: having the currents provided by the H branches to a given capacitor among the first and second capacitors, while the voltage across the other one of the first and second capacitors is reset by a respective reset switch; and
when the at least one multiplexer is in the second state: having the currents provided by the H branches to the other one of the first and second capacitors while the voltage across the given capacitor among the first and second capacitors is reset by the respective reset switch.

Thus, a capacitor is charged during the period T_{LO} and then discharged during the next period. This decorrelation between charge and discharge relaxes the requirements in terms of timings. For instance, this avoids potential glitches in the clocks, as well as the loss of current that is necessarily not integrated into the capacitor during the reset duration when such reset occurs during the same T_{LO} period than the charging of the capacitor.

In some embodiments, the at least one multiplexer comprises a first multiplexer and a second multiplexer. The output stage is configured for:
when the first multiplexer and the second multiplexer are in the first state: having the currents provided by the H branches to a given capacitor among the first and second capacitors through the first multiplexer, while the voltage across the other one of the first and second capacitors is reset by a respective reset switch, an ungrounded terminal of the given capacitor being connected to an output of the output stage through the second multiplexer; and
when the first multiplexer and the second multiplexer are in the second state: having the currents provided by the H branches to the other one of the first and second capacitors through the first multiplexer, while the voltage across the given capacitor among the first and second capacitors is reset by the respective reset switch, an ungrounded terminal of the other one of the first and second capacitors being connected to the output of the output stage through the second multiplexer.

In some embodiments, the system comprises a reconstruction block comprising, for each path, a switch, hereafter output switch, configured to connect the output of the output stage to an output of the reconstruction block. The clock system delivers N non-overlapping periodic clocks, hereafter reconstruction clocks, shifted by a duration substantially equal to T_{LO}/N in relation to each other, the period of the reconstruction clocks being T_{LO}, a duration of a ON state of the reconstruction clocks being substantially equal to T_{LO}/N. Each reconstruction clock is configured for triggering a respective output switch for having the output of the output stage provided to an output of the reconstruction block. The N output switches are triggered sequentially following a same ordering as the N sampled waveforms associated to the N paths when the sampled waveforms are ordered following the N successive time shifts of the sampling period T_{LO}/N.

Thus, the signal delivered at the output of the reconstruction block is up-converted back around the same center frequency as the input signal. The system thus behaves as a HR-NPF, but with the flexibility in the shape for the transfer function of the system.

In some embodiments, the reconstruction clocks and the sampling clocks are same clocks.

Thus, the implementation of the system is simpler.

Another aspect of the present disclosure relates to a receiver comprising a system for the selection of at least one frequency channel as discussed above (in any of the different embodiments discussed above).

Another aspect of the present disclosure relates to an integrated circuit comprising a receiver comprising a system for the selection of at least one frequency channel as discussed above (in any of the different embodiments discussed above).

### 4. LIST OF FIGURES

Other features and advantages of embodiments shall appear from the following description, given by way of indicative and non-exhaustive examples and from the appended drawings, of which:

FIG. 1, described above in relation with the section “Technological background”, illustrates a HR-NPM according to a known technic;

FIG. 1a, described above in relation with the section “Technological background”, illustrates the N sampling clocks used to trig the H branches of the N paths of the HR-NPM of FIG. 1;

FIG. 2 illustrates a system for the selection of at least one frequency channel in an input signal according to one embodiment of the present disclosure;

FIG. 2a illustrates the N reset clocks used to trig the reset switches of the capacitors of the N paths of the system of FIG. 2 according to one embodiment of the present disclosure;

FIG. 3 illustrates the theoretical transfer function for the system of FIG. 2 when tuned for the selection of two frequency channels according to one embodiment of the present disclosure;

FIG. 3a illustrates the transfer function simulated for a physical implementation of the system of FIG. 2 according to one embodiment of the present disclosure;

FIG. 4 illustrates the implementation of the output stage of the system of FIG. 2 according to another embodiment of the present disclosure;

FIG. 5 illustrates a system for the selection of at least one frequency channel in an input signal according to another embodiment of the present disclosure;

FIG. 5a illustrates the N reconstruction clocks used to trig the reconstruction switches of the system of FIG. 5 according to one embodiment of the present disclosure; and

FIG. 6 illustrates a receiver comprising the system for the selection of at least one frequency channel of FIG. 2 according to one embodiment of the present disclosure.

### 5. DETAILED DESCRIPTION

In all of the Figures of the present document, the same numerical reference signs designate similar elements and steps.

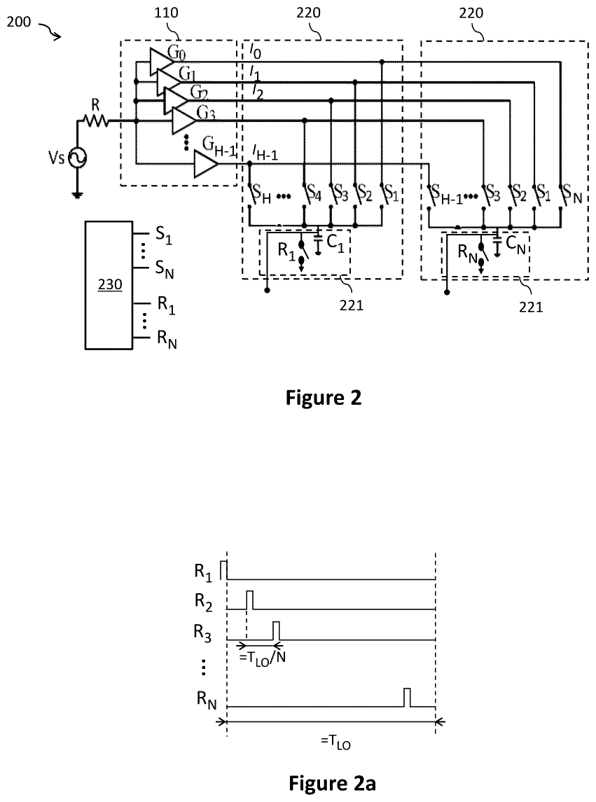

Referring now to FIG. 2 and FIG. 2a, we describe a system 200 for the selection of at least one frequency channel in an input signal according to one embodiment of the present disclosure.

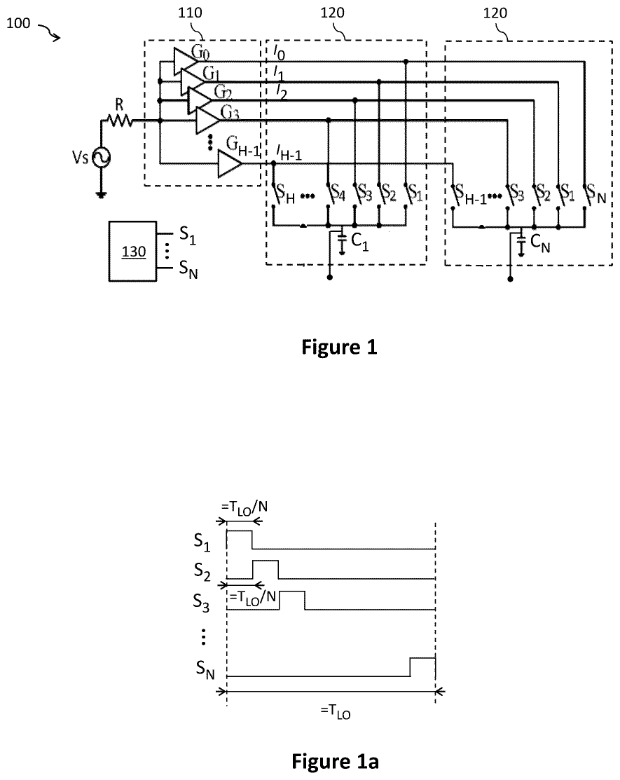

Compared to the HR-NPM of FIG. 1, each of the N processing paths 220 of the system 200 comprises an output stage 221 comprising:
the load capacitor C₁ or C₂ or . . . or C_{N}, and
one switch, hereafter reset switch, implemented in parallel of the load capacitor C₁ or C₂ or . . . or C_{N}.

The output of the output stage 221 delivers the voltage present across the respective load capacitor C₁ or C₂ or . . . or C_{N}. In other words, the output of the output stage 221 is connected to the ungrounded terminal of the respective load capacitor C₁ or C₂ or . . . or C_{N}.

In some embodiments, each output stage 221 comprises more than one load capacitor C₁ or C₂ or . . . or C_{N}, e.g. as in the embodiment of FIG. 4 discussed below. In the same way, in some embodiments, each output stage 221 comprises more than one reset switch, e.g. put in parallel of different load capacitors as in the embodiment of FIG. 4 discussed below.

Back to FIG. 2 and FIG. 2a, the clock system 230 of the system 200 delivers, in addition to the N sampling clocks S₁, S₂, . . . , S_{N}, N clocks R₁, R₂, . . . , R_{N}, hereafter reset clocks. Each reset clock trigs a respective reset switch for resetting the voltage across the capacitor C₁ or C₂ or . . . or C_{N} once per period T_{LO}.

More particularly, the reset, at each period T_{LO} of the sampling clocks, of the voltage across the output capacitors C₁, C₂, . . . , C_{N} of the N paths allows implementing a sampled pattern that does not need to be a periodic function of the sampling clock period T_{LO}. This provides flexibility in the shape for the transfer function of the system 200. For instance, a transfer function exhibiting a bandpass behavior centered around the frequency channel(s) to be selected can be implemented.

For instance, in some embodiments, the sampled pattern corresponds to the sampling of a sinewave. However, contrary to what is encountered according to the know technics, the frequency F_{c} of the sinewave can be different from F_{LO}=1/T_{LO}. For instance, the H gain factors Gₕ, with h from 0 to H−1, follow the equation:

$${G}_{h} = \frac{sin ( \frac{2 π \cdot {F}_{c}}{N \cdot {F}_{L O}} ( 1 + h ) )}{sin ( \frac{2 π \cdot {F}_{c}}{N \cdot {F}_{L O}} )} \qquad ( 1 )$$

This results in a transfer function of the system 200 that exhibits a bandpass behavior centered around the frequency channel corresponding to the frequency F_{c} of the sinewave.

Conversely, in some embodiments, the sampled pattern corresponds to the sampling of a sum of sinewaves. This results in a transfer function of the system 200 that exhibits, for each sinewave, a bandpass behavior centered around the frequency channel corresponding to the frequency of the sinewave. For instance, the H gain factors Gₕ, with h from 0 to H−1, follow the equation:

$${G}_{h} = {\sum }_{n = 1}^{{N}_{c}} {G}_{h , c n} \qquad ( 2 )$$

with:

$${G}_{h . cn} = \frac{sin ( \frac{2 π \cdot {F}_{cn}}{N \cdot {F}_{L O}} ( 1 + h ) )}{sin ( \frac{2 π \cdot {F}_{cn}}{N \cdot {F}_{L O}} )} \qquad ( 3 )$$

where N_{c} is the number of sinewaves and where F_{cn} is the frequency of the n-th sinewave. The aggregation of the frequency channels corresponding to the frequencies of the N_{c} sinewaves is thus obtained.

In order to illustrate the theoretical transfer function that can be expected for the system 200, let consider for the sake of simplicity the particular case where H is equal to N. In such case, the modulus of the transfer function H(f) can be expressed as:

$$\vert X ( f ) \cdot Y ( f ) ⋆ Z ( f ) \vert \qquad ( 4 )$$

where:

$$X ( f ) = sin c ( π \cdot {T}_{s} \cdot f ) \qquad ( 5 )$$

with Tₛ=1/Fₛ equal to T_{LO}/N. And where:

$$Y ( f ) = {\sum }_{c n = 1}^{N c} {\sum }_{n = − ∞}^{+ ∞} δ ( f − n \cdot N \cdot {F}_{L O} \pm {F}_{c n} ) \qquad ( 6 )$$

$$and$$

$$Z ( f ) = sin c ( π \cdot {T}_{LO} \cdot f ) \qquad ( 7 )$$

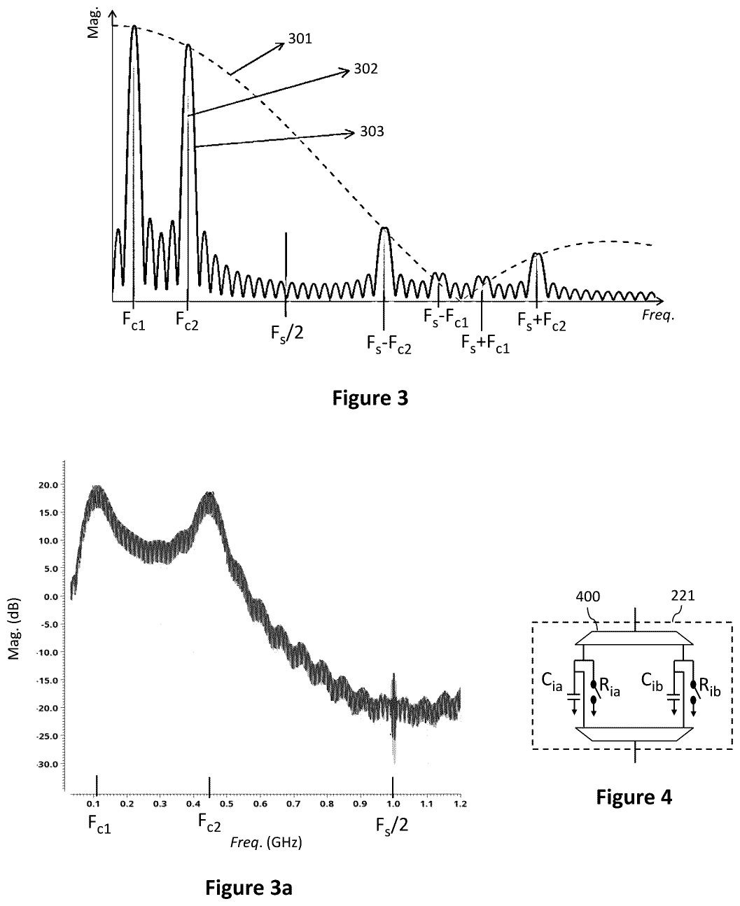

For instance, FIG. 3 illustrates the modulus of the transfer function H(f) obtained for two sinewaves with frequencies F_{c1} and F_{c2}. More particularly:
the curve 301 corresponds to the modulus of X(f);
the curve 302 corresponds to the modulus of X(f)·Y(f);
the curve 303 corresponds to the modulus of X(f)·Y(f)*Z(f).

We observe that the overall transfer function exhibits a bandpass filtering effect around the two frequencies F_{c1} and F_{c2}. The system 200 according to this example can thus be used for the selection (or aggregation) of two frequency channels centered around the two frequencies F_{c1} and F_{c2}.

FIG. 3a illustrates the modulus of the transfer function H(f) simulated in Cadence environment with Spectre simulator tool for the system 200 with N=32 and 1/T_{LO}=62.5 MHz, thus allowing to address the RF band of interest of 1 GHz, when implemented in a CMOS technology. The load capacitors are chosen as 50 pF. The gain factors are computed as the sampling of two sinewaves centered around the two frequencies F_{c1}=106.25 MHz and F_{c2}=450 MHz. As can be seen on the resulting curve, the present technic allows achieving a transfer function that exhibits a filtering effect around the two frequencies F_{c1} and F_{c2} thus allowing the selection (or aggregation) of the two corresponding frequency channels.

It is noted that the gain factors Gₕ also allow tuning the bandwidth BW of the transfer function of the system 200 around the frequency channel(s) to select. Indeed, such bandwidth BW is given by the formula BW=1/T_{LO} when the gain factors correspond to the values given by equations (2) and (3), i.e. to the sampling of one (or more) sinewave corresponding to the frequency channel(s) to select. Such bandwidth equal to 1/T_{LO} is the narrowest possible channel bandwidth (this situation corresponds to the case illustrated in FIG. 3 or in FIG. 3a discussed above). However, wider bandwidths can be achieved for each frequency channel by adjusting the gain factors Gₕ. For instance, instead of having gain factors that correspond, for each frequency channel, to the sampling of a sinewave, the sampling of a tapered sinewave can be used. Such tapering indeed widens the bandwidth of the main lobe in the transfer function.

Referring now to FIG. 4, we describe the implementation of the output stage 221 according to one embodiment of the present disclosure.

More particularly, in the embodiment of FIG. 2, at each sampling clocks period T_{LO}, the capacitor C₁ or C₂ or . . . or C_{N} is charged during a T_{LO} time interval and then discharged, ready for the next cycle of charge and discharge during the next T_{LO} time interval. The voltage at the capacitor C₁ or C₂ or . . . or C_{N} is then refreshed at each sampling clocks period T_{LO}. However, due to the reset occurring during the same T_{LO} period than the charging of the respective capacitor C₁ or C₂ or . . . or C_{N}, there may be a loss in the current that is necessarily not integrated into said capacitor C₁ or C₂ or . . . or C_{N} during the reset duration.

In order to overcome such limitation, according to the embodiment of FIG. 4 the i-th path, i from 1 to N, comprises an output stage 221 comprising:
a first capacitor Cᵢₐ and a second capacitor C_{ib};
a first reset switch configured to ground the first capacitor Cᵢₐ for resetting the voltage across the first capacitor when the first reset switch is ON; and
a second reset switch configured to ground the second capacitor C_{ib} for resetting the voltage across the second capacitor when the second reset switch is ON.

Each path comprises a multiplexer 400 configured for alternating between a first state and a second state, the change between the first state and the second state occurring at each sampling clock period T_{LO}. A considered path is configured for:
when the multiplexer 400 is in the first state: having the currents provided by the H branches to a given capacitor among the first capacitor Cᵢₐ and the second capacitor C_{ib}, while the voltage across the other one of the first capacitor Cᵢₐ and the second capacitor C_{ib} is reset by the respective reset switch; and
when the multiplexer 400 is in the second state: having the currents provided by the H branches to the other one of the first capacitor Cᵢₐ and the second capacitor C_{ib} while the voltage across the given capacitor among the first capacitor Cᵢₐ and the second capacitor C_{ib} is reset by the respective reset switch.

Thus, a given capacitor Cᵢₐ or C_{ib} is charged during a sampling clock period T_{LO} and then discharged during the next sampling clock period T_{LO}. This decorrelation between charge and discharge relaxes the requirements in terms of timings. For instance, this avoids potential glitches in the clocks, as well as the loss of current that is necessarily not integrated into the capacitor during the reset duration when such reset occurs during the same sampling clock period T_{LO} than the charging of the capacitor as discussed above in relation with FIG. 2.

In the embodiment of FIG. 4, each path comprises another multiplexer to multiplex the voltages across the first capacitor Cᵢₐ and the second capacitor C_{ib} to an output of output stage 221. In other words, the ungrounded terminal of the capacitor that receives the currents provided by the H branches is connected to the output of the output stage 221. However, in other embodiments, alternative ways of using the voltages across the first capacitor Cᵢₐ and the second capacitor C_{ib} can be considered, e.g. through their respective processing by a dedicated processing path.

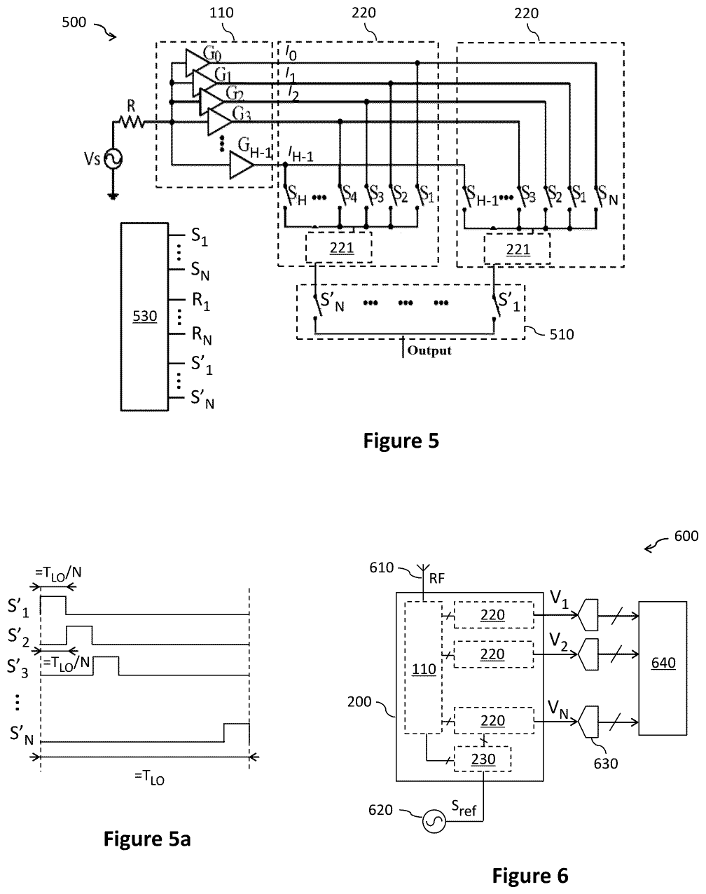

Referring now to FIG. 5 and FIG. 5a, we describe a system 500 for the selection of at least one frequency channel in an input signal according to one embodiment of the present disclosure.

More particularly, compared to the system 200 of FIG. 2, the system 500 comprises a reconstruction block 510 comprising, for each path, a switch, hereafter output switch, configured to connect the output of the output stage 221 to an output of the reconstruction block 510.

The clock system 530 delivers, in addition to the N sampling non-overlapping clocks, S₁, S₂, . . . , S_{N}, and to the N reset periodic clocks R₁, R₂, . . . , R_{N}, N non-overlapping periodic clocks, hereafter reconstruction clocks S′₁, S′₂, . . . , S′_{N}, shifted by a duration substantially equal to T_{LO}/N in relation to each other, the period of the reconstruction clocks S′₁, S′₂, . . . , S′_{N} being T_{LO}, a duration of a ON state of the reconstruction clocks S′₁, S′₂, . . . , S′_{N} being substantially equal to T_{LO}/N.

As discussed above, the ON state of such clock corresponds to the state of the clock that turns ON the switch that is trigged by the clock in question. For instance, the ON state of a clock that trigs a NMOS type transistor is the high voltage level of the clock. Conversely, the ON state of a clock that trigs a PMOS type transistor is the low voltage level of the clock.

Each reconstruction clock S′₁ or S′₂ or . . . or S′_{N} trigs a respective output switch for having the voltage across the respective load capacitor C₁ or C₂ or . . . or C_{N} provided to an output of the reconstruction block 510. The N output switches are trigged sequentially following a same ordering as the N sampled waveforms associated to the N paths when the sampled waveforms are ordered following the N successive time shifts of the sampling period T_{LO}/N.

Thus, in addition to the behavior of the system 200 that translates in frequency the spectrum of the input signal by an amount equal to F_{LO}=1/T_{LO}, the signal delivered at the output of the reconstruction bloc 510 is translated back in frequency around the same center frequency as the input signal. The system 500 thus behaves as a HR-NPF, but with the flexibility in the shape for the transfer function of the system as described above in relation with FIG. 2 and FIG. 2a.

In some embodiments of the system 200 or of the system 500, the number H of branches is equal to the number N of paths.

In some embodiments, the reconstruction clocks S′₁, S′₂, . . . , S′_{N} and the sampling clocks S₁, S₂, . . . , S_{N} are same clocks. Thus, the implementation of the system 200 or 500 is simpler.

Referring now to FIG. 6, we describe a receiver comprising the system 200 for the selection of at least one frequency channel according to one embodiment of the present disclosure.

More particularly, such a receiver 600 comprises a frequency synthesizer 620 delivering a reference signal at frequency F_{LO}=1/T_{LO} to the clock system 230. The clock system 230 thus generates the N sampling clocks S₁, S₂, . . . , S_{N} and the N reset clocks R₁, R₂, . . . , R_{N} to be delivered to the N processing paths 220 based on the reference signal.

Each processing path 220 delivers the voltage present at the output of the output stage 221 (i.e. the voltage across the ungrounded terminal of its load capacitor(s) C₁ or C₂ or . . . or C_{N} as discussed above in relation with FIG. 2, or Cᵢₐ, C_{ib} as discussed above in relation with FIG. 4) to a respective analog-to-digital converter, ADC, 630 delivering a respective sequence of samples. Such sequence of samples is thus a filtered and translated in frequency version of the input signal delivered by the receiving antenna 610 according to the processing detailed above. The N sequences of samples are further provided to a digital processing block 640 that demodulates the signal(s) present in the one (or more) frequency channel(s) selected by the system 200.

According to the architecture illustrated in FIG. 6, the receiver 600 comprises a system 200 according to any of the embodiments discussed above. However, equivalent receiver 600 architectures can be considered based on the use of a system 500 according to any of the embodiments discussed above.

In some embodiments, such receiver 600 (whether comprising a system 200 or a system 500) is implemented in an integrated circuit. Such integrated circuit is based e.g. on a CMOS or a bipolar technology.

1. A system for the selection of at least one frequency channel in an input signal, the system comprising:
a gain block configured to deliver H currents substantially proportional to said input signal through a respective gain factor, H being an integer greater than or equal to three;
N processing paths, N being an integer greater than or equal to H, configured to process said currents; and
a clock system configured to deliver N non-overlapping periodic clocks, hereafter sampling clocks, shifted by a duration substantially equal to T_{LO}/N in relation to each other, with T_{LO} being the period of the sampling clocks, an ON state of the sampling clocks being substantially equal to T_{LO}/N,
wherein each path comprises:
an output stage comprising at least one capacitor; and
H branches, each branch being configured to provide to the at least one capacitor, through a respective switch triggered by a respective sampling clock among said N sampling clocks, a respective current among said H currents, the H branches being configured to have the gain factors of the currents successively provided to the at least one capacitor over a period T_{LO} that are representative of a respective sampled waveform,
wherein the N respective sampled waveforms associated to the N paths are H first samples of the N circular permutations of a sampled pattern obtained by N successive time shifts of a sampling period T_{LO}/N,
the output stage comprises at least one reset switch, implemented in parallel of said at least one capacitor, and
said clock system is configured to deliver N reset clocks, each reset clock triggering a respective at least one reset switch for resetting the voltage across said at least one capacitor once per period T_{LO}.

2. The system according to claim 1, wherein the sampled pattern corresponds to the sampling of a sinewave, a frequency of the sinewave being different from 1/T_{LO}, said at least one frequency channel comprising a frequency channel centered on the frequency of the sinewave.

3. The system according to claim 1, wherein the sampled pattern corresponds to the sampling of a sum of sinewaves, said at least one frequency channel comprising, for each sinewave, a frequency channel centered on the frequency of the sinewave.

4. The system according to claim 1, wherein said at least one capacitor comprises a first capacitor and a second capacitor,
wherein said at least one reset switch comprises:
a first reset switch configured to ground the first capacitor for resetting the voltage across the first capacitor when the first reset switch is ON, and
a second reset switch configured to ground the second capacitor for resetting the voltage across the second capacitor when the second reset switch is ON,
wherein the output stage comprises at least one multiplexer configured to alternate between a first state and a second state, the change between the first state and the second state occurring at each sampling clock period T_{LO},
wherein the output stage is configured to:
when the at least one multiplexer is in the first state: having the currents provided by the H branches to a given capacitor among the first and second capacitors, while the voltage across the other one of the first and second capacitors is reset by a respective reset switch; and
when the at least one multiplexer is in the second state: having the currents provided by the H branches to the other one of the first and second capacitors while the voltage across the given capacitor among the first and second capacitors is reset by the respective reset switch.

5. The system according to claim 4, wherein said at least one multiplexer comprises a first multiplexer and a second multiplexer,
wherein the output stage is configured to:
when the first multiplexer and the second multiplexer are in the first state: having the currents provided by the H branches to a given capacitor among the first and second capacitors through the first multiplexer, while the voltage across the other one of the first and second capacitors is reset by a respective reset switch, an ungrounded terminal of the given capacitor being connected to an output of the output stage through the second multiplexer; and
when the first multiplexer and the second multiplexer are in the second state: having the currents provided by the H branches to the other one of the first and second capacitors through the first multiplexer, while the voltage across the given capacitor among the first and second capacitors is reset by the respective reset switch, an ungrounded terminal of the other one of the first and second capacitors being connected to the output of the output stage through the second multiplexer.

6. The system according to claim 1, further comprising a reconstruction block comprising, for each path, an output switch configured to connect the output of the output stage to an output of the reconstruction block,
wherein the clock system delivers N non-overlapping reconstruction clocks, shifted by a duration substantially equal to T_{LO}/N in relation to each other, the period of the reconstruction clocks being T_{LO}, a duration of a ON state of the reconstruction clocks being substantially equal to T_{LO}/N, and
wherein each reconstruction clock triggers a respective output switch for having the output of the output stage provided to an output of the reconstruction block, the N output switches being triggered sequentially following a same ordering as the N sampled waveforms associated to the N paths when the sampled waveforms are ordered following the N successive time shifts of the sampling period T_{LO}/N.

7. The system according to claim 6, wherein the reconstruction clocks and the sampling clocks are identical clocks.

8. A receiver comprising the system for the selection of at least one frequency channel according to claim 1.

9. An integrated circuit comprising the receiver according to claim 8.
